(19) United States
(12) Patent Application Publication
(10) Pub. No.: US 2022/0287430 A1
(43) Pub. Date: Sep. 15, 2022

(54) HAIR DYEING ACCESSORY AND HAIR DYEING GLOVE

(71) Applicant: Yutaka Hagiwara, Tsukuba-shi (JP)

(72) Inventor: Yutaka Hagiwara, Tsukuba-shi (JP)

(21) Appl. No.: 17/680,672

(22) Filed: Feb. 25, 2022

Related U.S. Application Data
(63) Continuation of application No. PCT/JP2020/031770, filed on Aug. 24, 2020.

(30) Foreign Application Priority Data
Aug. 26, 2019 (JP) 2019-153321
Mar. 27, 2020 (JP) 2020-059214

(51) Int. Cl. A45D 19/02; A45D 19/00; A41D 19/015; A61Q 5/10

(52) U.S. Cl. CPC A45D 19/028; A45D 19/0066; A41D 19/01594; A61Q 5/10

(57) ABSTRACT

A hair dyeing accessory for applying a hair coloring agent, such as a coloring agent or a gray hair dyeing agent for beauty and barber use, even to the roots of hair efficiently while making the amount of adhesion to the scalp small, and a hair dyeing glove using the same, are provided. A hair dyeing accessory disposed on a surface of a glove, the hair dyeing accessory including: a cloth that includes a reservoir space for retaining a dyeing agent; and a projection fixed to the cloth or the glove, wherein the cloth does not disturb contact of the projection with a scalp. A hair dyeing glove includes: a glove; and the hair dyeing accessory fixed to and disposed on the surface of the glove.

### TECHNICAL FIELD

The present invention relates to a hair dyeing accessory for applying a hair coloring agent, such as a coloring agent or a gray hair dyeing agent for beauty and barber use, even to the roots of hair efficiently while making the amount of adhesion to the scalp small, and a hair dyeing glove using the same.

### BACKGROUND ART

Typical conventional hair coloring methods include a method of applying a hair coloring agent directly onto hairs and spreading the agent with a comb, and a method of causing a two-pack dyeing agent to adhere to brush or a comb and applying the agent to and between hairs. On the other hand, there is an apparatus including teeth between which a dyeing agent is pushed out and applied to hairs.

Several combs dedicated to hair dyeing have been developed. All of them, however, use a large amount of a dyeing agent, and a large amount of the dyeing agent adheres also to the scalp. For example, those periodically having their hair dyed are required to apply a dyeing agent only around the roots of hair, while in a barber shop or the like, a dyeing agent is applied to the entire hair, and a large amount is used, in some cases.

On the other hand, Patent Literature 1 discloses

“Provided is a hair dyeing tool capable of helping evenly, beautifully and handily dyeing hair without staining the scalp, the face, the forehead, the neck or the like with a hair dyeing liquid and without soiling clothes or the like when the hair dyeing liquid is applied on the hairs, the hair dyeing tool including: a liquid-impermeable glove or finger sack; and an application member having a plurality of holes or grooves provided on a sheet provided with continuous openings, the member being pasted on the glove or finger. The hole or the groove has a size allowing a sufficient amount of the typically highly viscous hair dyeing liquid to be retained therein and allowing the dyeing liquid retained therein to be smoothly transferred to the hair by pressing-rubbing the hair with the hand or the fingers through the glove or the finger sack or holding and rubbing the hair between the fingers.”

Unfortunately, when the hair is subjected to pressing-rubbing with the fingers, possible pressing to the scalp side results in a large amount of application of hair dyeing agent to the scalp. On the other hand, only by pressing-rubbing with the fingers pinching the hair, dyeing around the roots of hair is insufficient. Furthermore, when only fingertips are used for dyeing, the part to be dyed in a single time is small region. Accordingly, a long time period is required to dye the entire hair, which is not efficient.

Note that Patent Literature 2 discloses a glove that includes a brush for dyeing hair. The brush includes standing straight pins. The brush is thermal-fusion-joined or adhering to the glove. Unfortunately, what includes the straight pins is not different from a conventional, commercially available brush with a handle used for dyeing, and cannot reduce the amount of adhesion of the hair dyeing agent to the scalp.

### CITATION LIST

### Patent Literature

Patent Literature 1: Japanese Patent Laid-Open No. 2005-270539
Patent Literature 2: Japanese Utility Model Application No. 1-137287

### SUMMARY OF INVENTION

### Technical Problem

The present invention has an object to provide a hair dyeing accessory for applying a hair coloring agent, such as a coloring agent or a gray hair dyeing agent for beauty and barber use, even to the root of hair efficiently while making the amount of adhesion to the scalp small, and a hair dyeing glove using the same.

### Solution to Problem

To solve the above problem, the present invention has any of the following configurations.

(1)

A hair dyeing accessory disposed on a surface of a glove, the hair dyeing accessory including:
a cloth that includes a reservoir space for retaining a dyeing agent; and a projection fixed to the cloth or the glove,

wherein the cloth does not disturb contact of the projection with a scalp.

(2)

A hair dyeing glove, including: a glove; and the hair dyeing accessory according to (1) fixed to and disposed on the surface of the glove.

(3)

A hair dyeing accessory that is a cloth that is disposed at a projection standing on a surface of a glove, has a reservoir space for retaining a dyeing agent, and is positioned closer to the glove than an end part of the projection,

wherein the cloth does not disturb contact of the end part of the projection with a scalp.

(4)

A hair dyeing glove, including: a glove; and a hair dyeing accessory according to (3) hooked and disposed on the projection standing on the surface of the glove.

(5)

The hair dyeing accessory according to (1) or (3), wherein the cloth is gathered.

(6)

A hair dyeing glove, including: a glove; a projection that includes a shaft standing on a surface of the glove, and an expanded part that is positioned at a distal end of the shaft and has a larger diameter than the shaft; and the hair dyeing accessory according to (3) hooked on and disposed at the projection,

wherein a reservoir space for retaining the dyeing agent around the shaft between the expanded part and the glove is also included.

(7)

A hair dyeing accessory that is hooked at a projection standing on a surface of a glove, and includes a reservoir space for retaining a dyeing agent around the projection, includes a distal end positioned closer to a root of the projection than an end part of the projection, and does not disturb contact of the end part of the projection with the scalp.

(8)

The hair dyeing accessory according to (7), further including: a ring part that encircles the projection; and a plurality of branches that radially project from the ring part toward a distal side of the projection,

wherein the reservoir space is a space encircled by the plurality of branches.

(9)

A hair dyeing accessory, including: the hair dyeing accessory according to (8); and a second hair dyeing accessory that is positioned in the reservoir space of the hair dyeing accessory according to (8), and includes branches shorter than the branches of the hair dyeing accessory according to (8).

(10)

The hair dyeing accessory according to (7), further including: a ring part that encircles the projection; a plurality of rails that protrude from the ring part and form arc shapes toward a distal side of the projection; and a second ring part that couples end parts of the rails, encircles the projection, and the accessory forming a bag shape,

wherein the reservoir space is a space encircled by the rails.

(11)

A hair dyeing glove, including the hair dyeing accessory according to any one of (7) to (10) attached to the projection on the glove,

wherein a distal end of the hair dyeing accessory is positioned closer to a root of the projection than an end part of the projection, and the end part of the projection comes into contact with a scalp.

(12)

The hair dyeing accessory according to (11), wherein the projection includes: a shaft standing on a surface of the glove; and an expanded part that is positioned at a distal end of the shaft, and has a larger diameter than the shaft, and

the expanded part prevents the hair dyeing accessory from being dropped off.

(13)

A hair dyeing accessory, including:

a sheet portion to be pasted on a glove;

a projection that stands on a surface of the sheet portion; and

a cloth that is disposed at the projection, has a reservoir space for retaining a dyeing agent, and is positioned closer to the glove than an end part of the projection,

wherein the cloth does not disturb contact of the end part of the projection with a scalp.

(14)

A hair dyeing accessory, including:

a sheet portion to be pasted on a glove; and

a projection that includes a shaft standing on a surface of the glove, and an expanded part that is positioned at a distal end of the shaft, and has a larger diameter than the shaft,

wherein a reservoir space for retaining a dyeing agent around the shaft between the expanded part and the sheet portion is included, and an end part of the projection comes into contact with a scalp.

(15)

The hair dyeing accessory according to (14), including:

the sheet portion to be pasted on the glove; and

the projection that includes the shaft standing on the surface of the glove, and the expanded part that is positioned at the distal end of the shaft, and has a larger diameter than the shaft,

wherein in the projection, the expanded part and the shaft are separately configured.

(16)

The hair dyeing accessory according to (15), including:

the sheet portion to be pasted on the glove;

the projection that includes the shaft standing on the surface of the glove, and the expanded part that is positioned at the distal end of the shaft, and has a larger diameter than the shaft, the expanded part and the shaft being separately configured; and

a member that is a cloth that is fitted to the shaft, includes a reservoir space for retaining the dyeing agent, is positioned closer to the glove than an end part of the projection, and does not disturb contact of the end part of the projection with the scalp,

or

a member that is fitted to the shaft, includes a reservoir space for retaining the dyeing agent around the projection, includes a distal end positioned closer to a root of the projection than an end part of the projection, and does not disturb contact of the end part of the projection with the scalp,

wherein the expanded part is a stopper preventing the member from being dropped off.

(17)

A hair dyeing accessory, including:

a sheet portion to be pasted on a glove;

a projection that stands on a surface of the sheet portion; and

a member that is hooked at the projection, and includes a reservoir space for retaining a dyeing agent around the projection, includes a distal end positioned closer to a root of the projection than an end part of the projection, and does not disturb contact of the end part of the projection with the scalp.

(18)

The hair dyeing accessory according to any one of (13) to (17), wherein the sheet portion, at positions corresponding to joint positions of fingers, is provided with notches for reducing bending resistances of the sheet portion against the fingers.

(19)

A hair dyeing glove, including: a glove; and the hair dyeing accessory according to any one of (13) to (18) pasted on the glove.

### Advantageous Effects of Invention

The present invention has the configuration described above. Accordingly, the present invention provides an object to provide a hair dyeing accessory for applying a hair coloring agent, such as a coloring agent or a gray hair dyeing agent for beauty and barber use, even to the root of hair efficiently while making the amount of adhesion to the scalp small, and a hair dyeing glove using the same. In particular, for gray hair dyeing, when hair grows, it is suitable for making the amount of adhesion to the scalp small, and intensively dyeing the root part of hair.

### BRIEF DESCRIPTION OF DRAWINGS

FIG. 1 is a perspective view of a first example of a hair dyeing glove according to the present invention worn up an arm 14.

FIG. 2 is a perspective view of a second example of a hair dyeing glove according to the present invention in wearing.

FIGS. 3(A) to 3(C) illustrate a hair dyeing accessory according to the present invention. FIG. 3(A) is a plan view of a cloth included in the hair dyeing accessory of the first example. FIG. 3(B) is a longitudinal sectional view of a finger portion of the first example of the hair dyeing glove where the first example of the hair dyeing accessory is fixed and disposed. FIG. 3(C) is a longitudinal sectional view of a finger portion of a third example of a hair dyeing glove where the cloth (hair dyeing accessory) included in the first example of the first example of the hair dyeing accessory is hooked on a projection of the glove.

FIG. 4 is a longitudinal exploded perspective view of a fourth example of a hair dyeing glove (a second example of a hair dyeing accessory) according to the present invention. A state of being attached to one projection of the hair dyeing glove (partial view) is shown. This also applies to FIGS. 6 and 7.

FIGS. 5(A) to 5(C) are a schematic view of a use state of the fourth example of the hair dyeing glove (the second example of the hair dyeing accessory). FIG. 5(A) is a partial sectional view before use. FIG. 5(B) shows situations where the hair dyeing accessory 3 is soaked in a dyeing agent 12. FIG. 5(C) shows a part having extended after the last dyeing (gray hair), and shows a part (C1) to which the dyeing agent 12 is to be applied, and a part (C2) having already been dyed. During application, an end part 24f of the projection 24b is in contact with a scalp 10, and thus prevents the scalp 10 from coming into contact with reservoir spaces 3e (dyeing agent 12) retaining the dyeing agent 12, thereby allowing the amount of the dyeing agent 12 adhering to the scalp 10 to be small. This reduces the impact on the scalp 10.

FIG. 6 is a longitudinal exploded perspective view of a fifth example of a hair dyeing glove (a third example of a hair dyeing accessory) according to the present invention.

FIG. 7 is a longitudinal exploded perspective view of a sixth example of a hair dyeing glove (a fourth example of a hair dyeing accessory) glove according to the present invention.

FIG. 8 is a perspective view of a seventh example of a hair dyeing glove according to the present invention worn up the arm 14.

### DESCRIPTION OF EMBODIMENTS

Hereinafter, referring to the accompanying drawings, the embodiments of the present invention are described in detail. Note that the present invention is not limited to the following embodiments.

### Embodiment 1

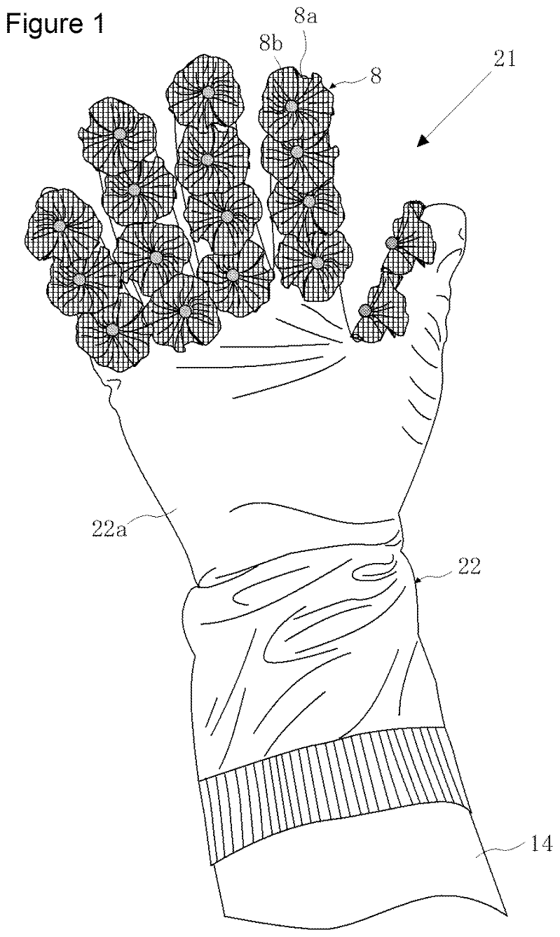

As shown in FIG. 1, a hair dyeing glove 21 according to the present invention includes a glove 22, and hair dyeing accessories 8. Each hair dyeing accessory 8 includes a cloth 8a, and a projection 8b.

A glove that is made of natural rubber, synthetic rubber, resin, or plastic, and has a property without chemical penetration (impermeant property and watertightness) so that no chemical passes through the glove and adhere to a hand in the inside of the glove during a dyeing operation, and has chemical resistance, solvent resistance, and deterioration resistance properties allowing repetitive uses, is suitable for the glove 22.

Examples of the materials of the glove 22 include, for instance, chloroprene rubber, chlorosulfonated polyethylene rubber, nitrile rubber, polyurethane rubber, butyl rubber, fluorine-containing rubber, silicone rubber, polyvinyl chloride, polyvinyl alcohol, and polyethylene.

The cloth 8a is disposed on the palm side 22a of the glove 22, and has reservoir spaces that retain a dyeing agent for dyeing hair. The reservoir spaces are spaces between the knitted stiches of the cloth, or between strings. Accordingly, the cloth 8a may be what is regularly knitted using strings or a non-woven cloth. As described later, the cloth 8a does not disturb contact of the projection 8b with a scalp 10.

An example of the projection 8b may be, for example, a bead, an imitation pearl or the like, which is fixed to the cloth 8a or the glove 22. In consideration of contact of the projection 8b with the scalp 10 and of cleaning, fixation of a spherical object with an adhesive is suitable.

More specifically, as shown in FIG. 1, the plurality of hair dyeing accessories 8 are disposed on finger portions of the glove 22 on the palm side 22a. The disposition places, such as the palm side 22a, fingertips and sides of fingers, may be freely selected, and the number of disposed items may also be freely selected.

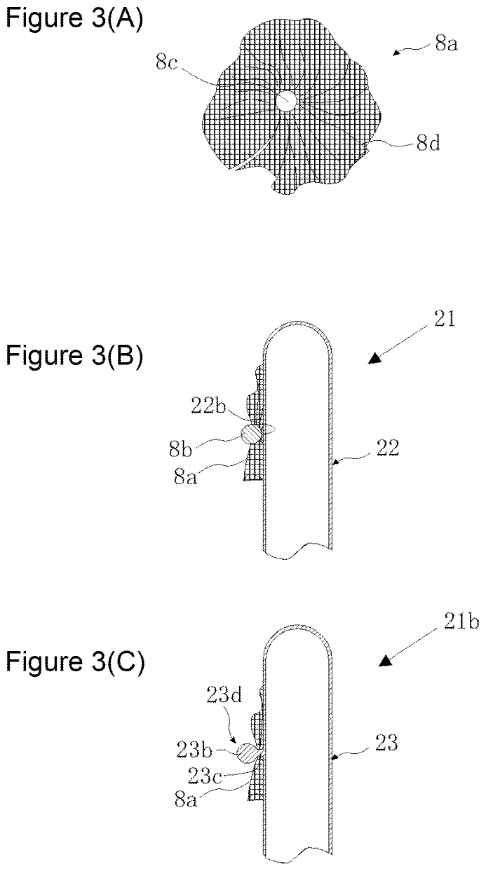

The cloth 8a is woven with strings. As shown in FIG. 3(A), a hole 8c is formed at the center. Gathers sewn from the center toward the edge to shrink the cloth (the edge portion along the hole 8c is sewn to shrink the close) are formed, or the gathers are formed by folding (gathers 8d). By forming the gathers 8d on the cloth 8a, not only spaces between strings and seams but also folded portions of the gathers are filled with a dyeing agent. After one-time filling of the dyeing agent, the dyeing agent can be applied to a wide area of hair, and the operability is high. The planar shape of the cloth 8a is not specifically limited, and may be a circular- or square-shaped.

As shown in FIG. 3(B), examples of fixation of the cloth 8a to the glove 22 include a method of achieving direct adhesion to the cloth 8a with an adhesive 22b or the like, or of bonding the projection 8b to the glove 22 with the adhesive 22b and fixing the intervening cloth 8a.

The fixation of the projection 8b may be any of fixation to the cloth 8a and fixation to the glove 22. Examples of fixation of the projection 8b to the cloth 8a may be adhesion with the adhesive 22b, or sewing with strings. Alternatively, examples of fixation of the projection 8b to the glove 22 may be adhesion with the adhesive 22b. The adhesive 22b is not specifically limited only if it has resistance to the dyeing agent. However, a gel-type instant adhesive is easy to handle.

### Embodiment 2

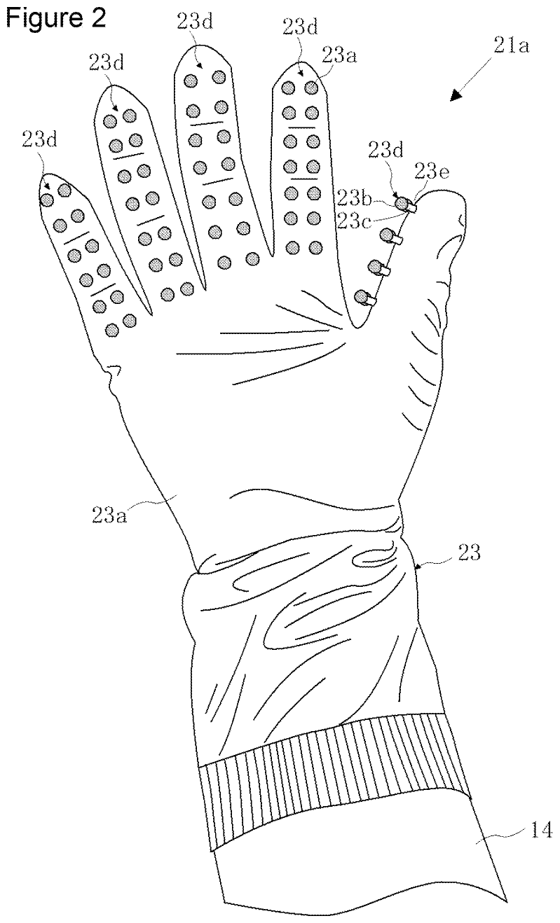

As shown in FIG. 2, a hair dyeing glove 21a according to the present invention includes a glove 23, and projections 23d. Each projection 23d includes: a shaft 23c standing on the palm side 23a of the glove 23; and an expanded part 23b that has a larger diameter than the shaft 23c and is disposed at the distal end of the shaft 23c. As a result, a reservoir space 23e for retaining a dyeing agent is formed around the shaft 23c between the expanded part 23b and the glove 23. Consequently, the projections 23d can be regarded as hair dyeing accessories. The glove 23 includes the glove 22, and the projections 23d.

More specifically, as shown in FIG. 2, the plurality of projections 23d are disposed on finger portions of on the palm side 23a of the glove 23. The disposition places, such as the palm side 23a, fingertips and sides of fingers, may be freely selected, and the number of disposed items may also be freely selected.

### Embodiment 3

As shown in FIG. 3(C), a hair dyeing glove 21b according to the present invention is made by disposing the holes 8c of the cloths 8a shown in FIG. 3(A) at the respective shafts 23c, and then hooking the cloth 8a at the projections 23d of the hair dyeing glove 21a of the embodiment 2. That is, the cloths 8a are disposed closer to the glove 23 than the end parts of the projections 23d. The expanded parts 23b respectively prevent the cloths 8a (hair dyeing accessories) from easily being dropped off.

### Embodiment 4

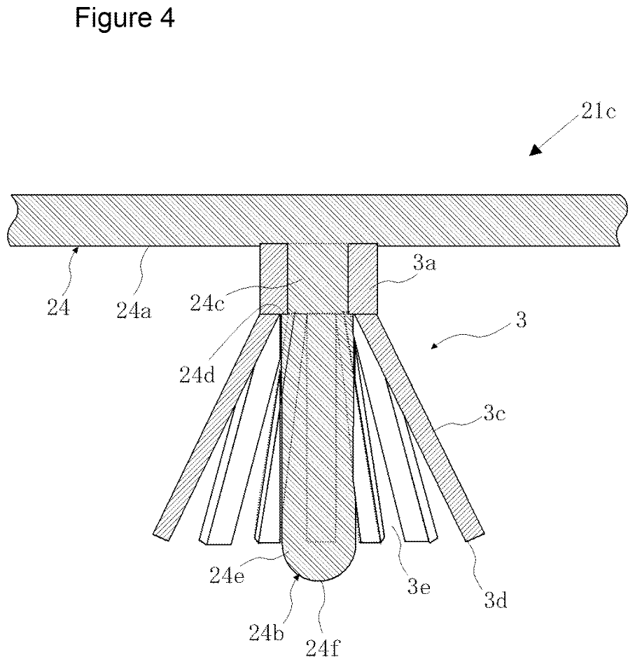

As shown in FIG. 4, a hair dyeing glove 21c according to the present invention includes a glove 24 (partially shown), and hair dyeing accessories 3. The glove 24 includes the glove 22, and projections 24b standing therefrom. They stand mainly on the palm side 24a.

Each hair dyeing accessory according to the present invention is hooked at the corresponding projection standing on the surface of the glove, and includes a reservoir space for retaining a dyeing agent around the projection. The distal end of the accessory is positioned closer to the root of the projection than the end part of the projection, which does not disturb contact of the end part of the projection with the scalp.

Most preferably, the distance between the end part of the projection and the distal end of the hair dyeing accessory ranges from 1 to 3 mm. The contact of the end part of the projection with the scalp can reduce the amount of application of the dyeing agent to the scalp, and facilitate sufficient distribution, infiltration, and spread of the dyeing agent also around the roots of hair.

As shown in FIG. 4, the hair dyeing accessory 3 includes: a ring part 3a encircling the projection 24b; a plurality of branches 3c radially protruding from the ring part 3a toward the distal side of the projection 24b. A reservoir space 3e is formed in a space encircled by the plurality of branches 3c.

The number of attached hair dyeing accessories 3 is appropriately selected depending on the intervals of the projections 24b, the sizes of the hair dyeing accessories 3, the place and range of application of the dyeing agent 12. Furthermore, in a case where the hair dyeing accessories 3 are detachably attached to the respective projections 24b, the arrangement positions and number of hair dyeing accessories 3 can be changed every time they are used.

Here, each projection 24b includes a shaft 24c, and an expanded part 24e positioned at the distal end, thus forming a step 24d. A ring part 3a is fitted on the shaft 24c, and the ring part 3a is engaged at the step 24d, thereby preventing the hair dyeing accessory 3 from being easily dropped off.

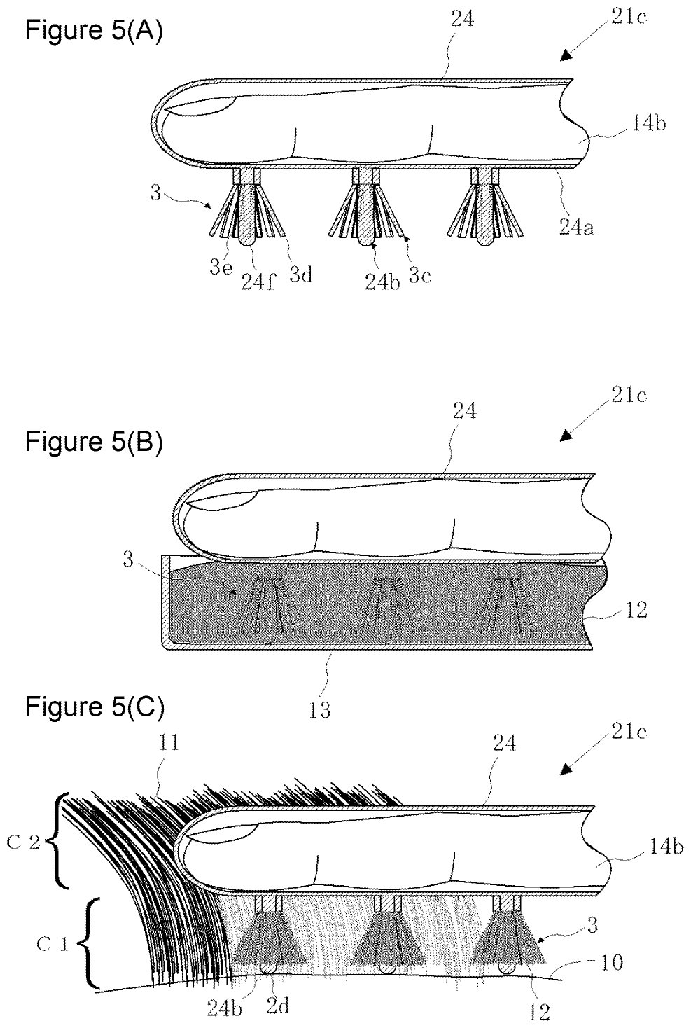

The hair dyeing glove 21c is used as shown in FIGS. 5(A) to 5(C). The hair dyeing accessories 3 shown in FIG. 5(A) are brought into contact with a paste-like dyeing agent 12 (a gray hair dyeing agent, two-pack dyeing agent, etc.) retained in a vessel 13 or the like as shown in FIG. 5(B), thereby allowing the reservoir spaces 3e of the hair dyeing accessories 3 to be filled with the dyeing agent 12. The dyeing agent 12 is charged and held in the reservoir spaces 3e due to the capillary action, surface tension, or the viscosity of the dyeing agent 12.

Since the dyeing agent 12 is thus retained in the reservoir spaces 3e, the dyeing agent 12 is not required to be directly applied to the hair 11 and be spread with a comb or the like. The dyeing agent 12 is retained once, the hair dyeing glove 21c is positioned as shown in FIG. 5(c), and a finger 14a is laterally wiggled. Accordingly, a part (C1 range) of the hair 11 that is around the root, has newly grown and not been dyed comes into contact with the dyeing agent 12, and the dyeing agent 12 can be applied to a wide range around the root of the hair 11 in a short time period. On the other hand, there is no need to dye a part (C2) of the hair 11 that has already been dyed and is not required to be newly dyed. This facilitates the hair dyeing operation. Thus, this can reduce the amount of application of the dyeing agent 12 to the scalp 10, and facilitate sufficient distribution, infiltration, and spread of the dyeing agent also around the roots of the hair 11.

### Embodiment 5

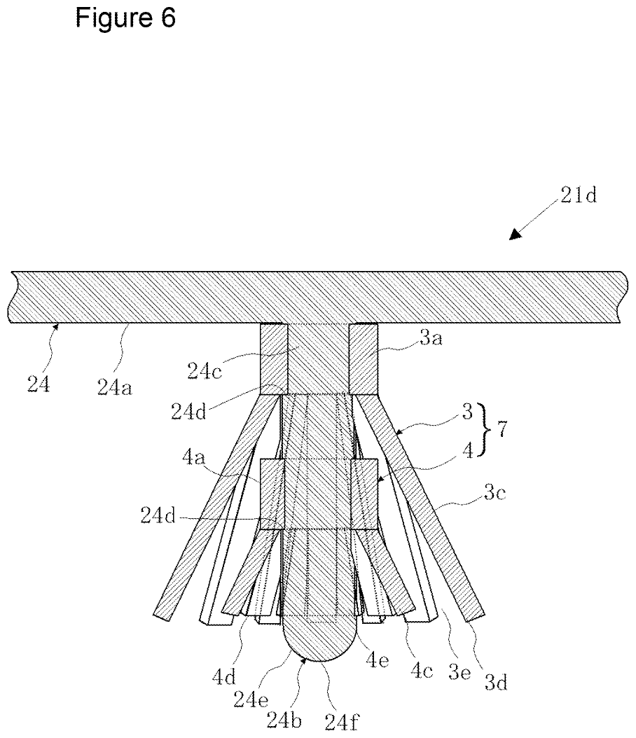

As shown in FIG. 6, a hair dyeing glove 21d according to the present invention includes: a glove 24 (partially shown); hair dyeing accessories 3; and second hair dyeing accessories 4 disposed in the reservoir spaces of the respective hair dyeing accessories 3. Each set of the hair dyeing accessory 3 and the hair dyeing accessory 4 constitutes a hair dyeing accessory 7.

The hair dyeing accessory 4 is a hair dyeing accessory 3 but includes branches 4c shorter than the branches 3c. That is, the hair dyeing accessory 4 includes: a ring part 4a that is positioned between the ring part 3a and the projection 24b and encircles the projection 24b; a plurality of branches 4c radially protruding from the ring part 4a toward the distal side of the projection 24b. A reservoir space 4e is formed in a space encircled by the plurality of branches 4c. The distal ends 4d are positioned closer to the root of the projection 24b than the end part 24f of the projection 24b. Further preferably, the distal ends 4d are positioned closer to the roots of the projection 24b than the distal ends 3d of the branches 3c. In addition, in FIG. 6, the hair dyeing accessories 3 and 4 are used in a two-fold configuration. More hair dyeing accessories may be further added, and the accessories may be used in a three-fold or four-fold configuration.

In this case, a space between the branches 4c and 3c also constitute the reservoir space 3e. In comparison with the single type hair dyeing accessories 3, the hair dyeing accessories 4 allow the dyeing agent 12 to be more easily charged in the reservoir space and to be stably held. This is because it is conceivable that the capillary action, surface tension, suction due to the viscosity of the dyeing agent, or entanglement, or the combination thereof is improved.

### Embodiment 6

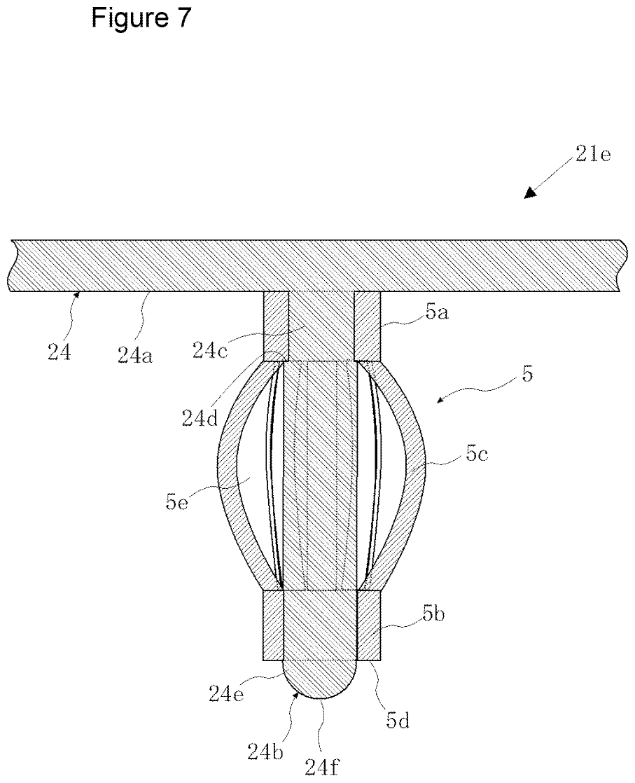

As shown in FIG. 7, a hair dyeing glove 21e according to the present invention includes a glove 24 (partially shown), and hair dyeing accessories 5. As shown in FIG. 7, each hair dyeing accessory 5 includes: a ring part 5a that encircles a projection 24b; a plurality of rails 5c that protrude from the ring part 5a and form arc shapes toward the distal side of the projection 24b; and a second ring part 5b that couples the end parts of the rails 5c, and encircles the projection 24b, thus forming a bag shape.

A reservoir space 5e is formed at a space encircled by the plurality of rails 5c. Through an operation similar to that in FIG. 5(B), the reservoir space 5e is filled with the dyeing agent 12 through the interspaces between the rails 5c.

The distal end 5d of the second ring part 5b is positioned closer to the root of the projection 24b than the end part 24f of the projection 24b. The projection 24b does not prevent the end part 24f of the projection 24b from coming into contact with the scalp 10.

The roots of the hair 11 come into contact with the dyeing agent 12 charged and retained in the reservoir space 5e, which is the space encircled by the rails 5c, and the roots of the hair 11 are intensively dyed.

### Embodiment 7

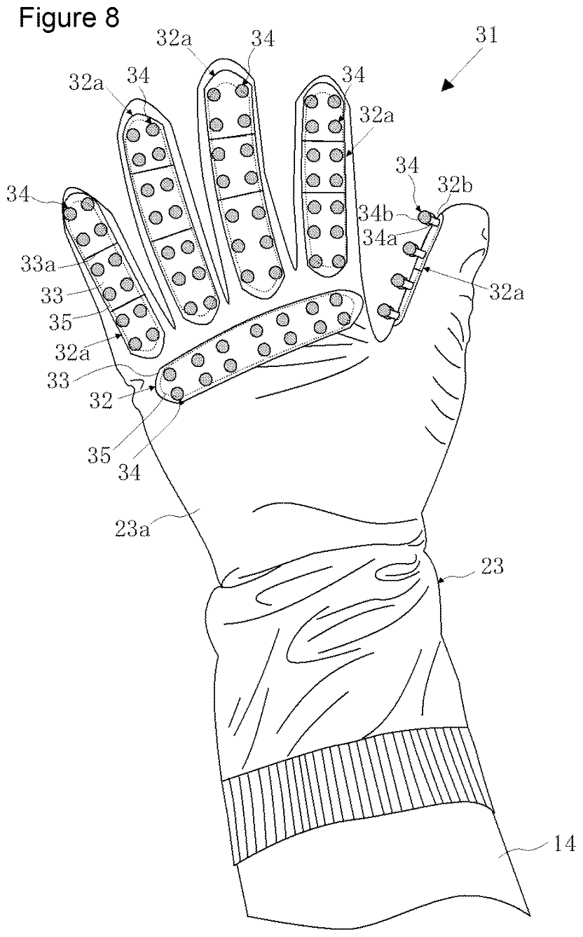

As shown in FIG. 8, a hair dyeing glove 31 according to the present invention includes a glove 23, and hair dyeing accessories 32 and/or hair dyeing accessories 32a. The glove 23 is made of a material similar to that of the glove 22, and may be a glove made of generally, commercially available rubber, or thin plastic film.

The hair dyeing accessory 32 includes: a sheet portion 33 to be pasted onto a finger or the palm of the glove 23; projections 34 that each include a shaft 34a standing on the surface of the sheet portion 33, and an expanded part 34b that is disposed at the distal end of the shaft 34a and has a larger diameter than the shaft 34a; and a reservoir space 32b that retains a dyeing agent around the shaft 34a between the expanded part 34b and the sheet portion 33. The end part of the projection 34 comes into contact with the scalp 10, and suppresses a large amount of adhesion of the dyeing agent to the scalp 10.

Here, pasting of the sheet portion 33 to the glove 23 is simple. Accordingly, a double-sided tape 35 is used. Other pasting means, adhesives, thermal fusion joining and the like can be exemplified. For each finger, the hair dyeing accessory 32a may be adopted that is provided with notches 33a (thin parts) to reduce the bending resistance of sheet portion 33 against the finger, at positions corresponding to joints of the finger.

Here, two rows of the projections 34 are adopted. Alternatively, one row or three rows may be provided. Preferably, the standing density may be that with intervals of standing shafts 34a ranging from 5 to 7 mm, which is of a commercially available brush. Two or more hair dyeing accessories each including a single row of projections 34 may be pasted on one finger or the palm. The length of the shaft 34a may be appropriately selected depending on an object to be dyed.

Preferably, the hair dyeing accessories 32 and 32a are made of a material, such as a resin or silicone, and made by integral molding. It is preferable that the hardness and flexibility be about those of a commercially available brush. On the other hand, the shaft 34a may be molded so that the expanded part 34b is separated from the shaft 34a. The shaft 34a and the expanded part 34b may then be fitted to each other and constitute the projection 34. In this case, fixation may be achieved with an adhesive.

Another member (another hair dyeing accessory) forming the reservoir space 32b may be fitted on the shaft 34a, and then the expanded part 34b may be fitted to the shaft 34a, thus allowing the expanded part 34b to function as a stopper for preventing the other hair dyeing accessory from being dropped off. Note that in the case where the other member (other hair dyeing accessory) forming the reservoir space 32b around the shaft 34a is provided, only the shaft 34a without the expanded part 34b of the projections 34 may be configured as the projection 24b as shown in FIG. 4.

The other hair dyeing accessory may be a member that is fitted on the shaft 34a, includes the reservoir space for retaining the dyeing agent 12, is disposed closer to the glove 23 than the end part of the projection 34, and does not prevent the projection 34 from coming into contact with the scalp 10; for example, the accessory may be the cloth 8a.

Another example of the other hair dyeing accessory may be a member which is fitted on the shaft 34a, and includes the reservoir space for retaining the dyeing agent 12, around the projections 34, of which distal end is positioned closer to the root of the projection 34 than the end part of the projection 34, and does not prevent the projection 34 from coming into contact with the scalp 10; for example, the hair dyeing accessory 3, the hair dyeing accessory 7, and the hair dyeing accessories 5 may be adopted. Note that the hair dyeing accessory 3, the hair dyeing accessory 7, and the hair dyeing accessories 5 may be integrally formed with the shaft 34a.

### REFERENCE SIGNS LIST

3 Hair dyeing accessory
3a Ring part
3c Branch
3d Distal end
3e Reservoir space
4 Hair dyeing accessory
4a Ring part
4c Branch
4d Distal end
4e Reservoir space
Hair dyeing accessory
5a Ring part
5b Second ring part
5c Rail
5d Distal end
5e Reservoir space
7 Hair dyeing accessory
8 Hair dyeing accessory
8a Cloth
8b Projection
8c Hole
8d Gather
10 Scalp
11 Hair
12 Dyeing agent
13 Vessel
14 Arm
14a Finger
21 Hair dyeing glove
21a Hair dyeing glove
21b Hair dyeing glove
21c Hair dyeing glove
21d Hair dyeing glove
21e Hair dyeing glove
22 Glove
22a Palm side
22b Adhesive
23 Glove
23a Palm side
23b Expanded part
23c Shaft
23d Projection
23e Reservoir space
24 Glove
24a Palm side
24b Projection
24c Shaft
24d Step
24e Expanded part
24f End part
31 Hair dyeing glove
32 Hair dyeing accessory
32a Hair dyeing accessory
32b Reservoir space
33 Sheet portion
33a Notch
34 Projection
34a Shaft
34b Expanded part
35 Double-sided tape

1. A hair dyeing accessory disposed on a surface of a glove, the hair dyeing accessory comprising:
a cloth that includes a reservoir space for retaining a dyeing agent; and a projection fixed to the cloth or the glove,
wherein the cloth does not disturb contact of the projection with a scalp.

2. A hair dyeing glove, comprising: a glove; and the hair dyeing accessory according to claim 1 fixed to and disposed on the surface of the glove.

3. A hair dyeing accessory that is a cloth that is disposed at a projection standing on a surface of a glove, has a reservoir space for retaining a dyeing agent, and is positioned closer to the glove than an end part of the projection,
wherein the cloth does not disturb contact of the end part of the projection with a scalp.

4. A hair dyeing glove, comprising: a glove; and the hair dyeing accessory according to claim 3 hooked and disposed on the projection standing on the surface of the glove.

5. The hair dyeing accessory according to claim 1, wherein the cloth is gathered.

6. A hair dyeing glove, comprising: a glove; a projection that includes a shaft standing on a surface of the glove, and an expanded part that is positioned at a distal end of the shaft and has a larger diameter than the shaft; and the hair dyeing accessory according to claim 3 hooked on and disposed at the projection, wherein a reservoir space for retaining the dyeing agent around the shaft between the expanded part and the glove is also included.

7. A hair dyeing accessory that is hooked at a projection standing on a surface of a glove, and includes a reservoir space for retaining a dyeing agent around the projection, includes a distal end positioned closer to a root of the projection than an end part of the projection, and does not disturb contact of the end part of the projection with the scalp.

8. The hair dyeing accessory according to claim 7, further comprising: a ring part that encircles the projection; and a plurality of branches that radially project from the ring part toward a distal side of the projection,
wherein the reservoir space is a space encircled by the plurality of branches.

9. A hair dyeing accessory, comprising: the hair dyeing accessory according to claim 8; and a second hair dyeing accessories that is positioned in the reservoir space of the hair dyeing accessory, and includes branches shorter than the branches of the hair dyeing accessory.

10. The hair dyeing accessory according to claim 7, further comprising: a ring part that encircles the projection; a plurality of rails that protrude from the ring part and form arc shapes toward a distal side of the projection; and a second ring part that couples end parts of the rails, encircles the projection, and the accessory forming a bag shape,
wherein the reservoir space is a space encircled by the rails.

11. A hair dyeing glove, comprising the hair dyeing accessory according to claim 7 attached to the projection on the surface of the glove,
wherein a distal end of the hair dyeing accessory is positioned closer to a root of the projection than an end part of the projection, and the end part of the projection comes into contact with a scalp.

12. The hair dyeing glove according to claim 11, wherein the projection includes: a shaft standing on a surface of the glove; and an expanded part that is positioned at a distal end of the shaft, and has a larger diameter than the shaft, and
the expanded part prevents the hair dyeing accessory from being dropped off.

13. A hair dyeing accessory, comprising:
a sheet portion to be pasted on a glove;
a projection that stands on a surface of the sheet portion; and
a cloth that is disposed at the projection, has a reservoir space for retaining a dyeing agent, and is positioned closer to the glove than an end part of the projection,
wherein the cloth does not disturb contact of the end part of the projection with a scalp.

14. A hair dyeing accessory, comprising:
a sheet portion to be pasted on a glove; and
a projection that includes a shaft standing on a surface of the sheet portion, and an expanded part that is positioned at a distal end of the shaft, and has a larger diameter than the shaft,
wherein a reservoir space for retaining a dyeing agent around the shaft between the expanded part and the sheet portion is included, and an end part of the projection comes into contact with a scalp.

15. The hair dyeing accessory according to claim 14, comprising:
the sheet portion to be pasted on the glove; and
the projection that includes the shaft standing on the surface of the sheet portion, and the expanded part that is positioned at the distal end of the shaft, and has a larger diameter than the shaft,
wherein in the projection, the expanded part and the shaft are separately configured.

16. The hair dyeing accessory according to claim 15, comprising:
the sheet portion to be pasted on the glove;
the projection that includes the shaft standing on the surface of the glove, and the expanded part that is positioned at the distal end of the shaft, and has a larger diameter than the shaft, the expanded part and the shaft being separately configured; and
a member that is a cloth that is fitted to the shaft, includes a reservoir space for retaining the dyeing agent, is positioned closer to the glove than an end part of the projection, and does not disturb contact of the end part of the projection with the scalp,
or
a member that is fitted to the shaft, includes a reservoir space for retaining the dyeing agent around the projection, includes a distal end positioned closer to a root of the projection than an end part of the projection, and does not disturb contact of the end part of the projection with the scalp,
wherein the expanded part is a stopper preventing the member from being dropped off.

17. A hair dyeing accessory, comprising:
a sheet portion to be pasted on a glove;
a projection that stands on a surface of the sheet portion; and
a member that is hooked at the projection, and includes a reservoir space for retaining a dyeing agent around the projection, includes a distal end positioned closer to a root of the projection than an end part of the projection, and does not disturb contact of the end part of the projection with the scalp.

18. The hair dyeing accessory according to claim 13,
wherein the sheet portion, at positions corresponding to joint positions of fingers, is provided with
notches for reducing bending resistances of the sheet portion against the fingers.

19. A hair dyeing glove, comprising: a glove; and the hair dyeing accessory according to claim 13 pasted on the glove.
